(19) United States
(12) Patent Application Publication
(10) Pub. No.: US 2024/0322556 A1
(43) Pub. Date: Sep. 26, 2024

(54) NETWORK-BASED ARC DETECTION AND MITIGATION IN DC POWER DISTRIBUTION SYSTEM

(71) Applicant: Apple Inc., Cupertino, CA (US)

(72) Inventors: Anthony Da Costa, Pacifica, CA (US); Stephen C Sherbrook, San Jose, CA (US); Kevin J White, Los Gatos, CA (US)

(21) Appl. No.: 18/219,310

(22) Filed: Jul. 7, 2023

Related U.S. Application Data
(60) Provisional application No. 63/453,685, filed on Mar. 21, 2023.

(51) Int. Cl. H02H 7/22; H02H 1/00

(52) U.S. Cl. CPC H02H 7/22; H02H 1/0015

(57) ABSTRACT

DC power systems operating at 48 V and higher may increase risk for sustained electrical arcs. In particular, a series arc may be formed and sustained when a connection fails open between a power source and an electrical load that continues to operate while the arc is present. In some applications, many or all modules may already be interconnected via network links, such as a Controller Area Network (CAN) bus, a Local Interconnect Network (LIN) bus, Ethernet, and so on. An arc detection and mitigation system may leverage an existing communication network to enable arc detection and mitigation while avoiding excessive additive costs.

### CROSS-REFERENCE TO RELATED APPLICATION

This application claims priority to U.S. Provisional Application No. 63/453,685, filed Mar. 21, 2023, entitled “NETWORK-BASED ARC DETECTION AND MITIGATION IN DC POWER DISTRIBUTION SYSTEM,” the disclosure of which is incorporated by reference in its entirety for all purposes.

### BACKGROUND

The present disclosure relates generally to DC power distribution systems, and more specifically to arc detection and mitigation in DC power distribution systems.

DC power systems operating at relatively high voltages (e.g., greater than 48 volts (V)) may increase the risk for sustained electrical arcs and/or the extent of such sustained electrical arcs. In particular, a series arc may be formed and sustained when a connection fails open between a power source and an electrical load that continues to operate while the series arc is present. Additionally or alternatively, the series arc may be generated in a circuit where a current is already established when the circuit becomes open due to conductor or connector failure. Such a sustained electrical arc may damage the circuit, among other negative effects, in many applications.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system includes an electrical load, load circuitry coupled to the electrical load and configured to output first data indicative of a first average of input load voltages across the electrical load, a power source, and power source circuitry coupled to the power source and the load circuitry, the power source circuitry configured to interrupt the power source based on the first data indicative of the first average of the input load voltages and second data indicative of a second average of power source bus voltages.

In another embodiment, an arc detection circuit includes a power bus, a power source coupled to the power bus, and power source circuitry coupled to the power source and the power bus. The power source circuitry includes a source voltage sensor configured to determine output voltages on the power bus, and a first microcontroller unit (MCU) coupled to the source voltage sensor and configured to output first data indicative of a first average of the output voltages received from the source voltage sensor. The arc detection circuit also includes an electrical load coupled to the power bus, and load circuitry coupled to the power bus and the electrical load. The load circuitry includes a load voltage sensor configured to determine input voltages across the electrical load, and a second MCU coupled to the load voltage sensor and configured to cause a load power reduction based on the first data indicative of the first average of the output voltages and second data indicative of a second average of the input voltages.

In yet another embodiment, a tangible, non-transitory, computer-readable medium includes instructions that, when executed by one or more processors, are configured to cause the one or more processors to perform various functions. The functions include determining output voltages corresponding to a power source, determining a first average of the output voltages, determining input voltages corresponding to a load coupled to the power source, determining a second average of the input voltages, and interrupting a flow of power from the power source to the load based on the first average of the output voltages and the second average of the input voltages.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic illustration of a circuit in a first condition without an electrical arc and a second condition with an electrical arc, according to embodiments of the present disclosure;

FIG. 2 is a schematic illustration of a power system including a power source, a load, and an arc detection system, according to embodiments of the present disclosure;

FIG. 3 is a process flow diagram illustrating a method of employing the arc detection system of the power system of FIG. 2 to detect an electrical arc via at least a power source microcontroller unit (MCU), according to embodiments of the present disclosure; and

FIG. 4 is a process flow diagram illustrating a method of employing the arc detection system of the power system of FIG. 2 to detect an electrical arc via at least a load microcontroller unit (MCU), according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

As power electronic systems offer power conversion between different voltage levels and/or between alternating current (AC) and direct current (DC) with increasing efficiency and/or lower cost, DC power distribution becomes increasingly present in various applications, such as automotive applications, telecom applications, solar applications, and so on. With increasing power levels, voltages may increase to limit current in converters and conductors. For example, 24-volt (V) and 48 V systems are beginning to be introduced as part of low voltage networks, in contrast with a traditional 12 V DC power system. In some cases, DC power systems may operate at voltages ranging from 100 V to several hundred volts.

DC power systems operating at 48 V and higher may increase risk for sustained electrical arcs. In particular, a series arc may be formed and sustained when a connection fails open between a power source and an electrical load that continues to operate while the series arc is present. Additionally or alternatively, the series arc may be generated in a circuit where a current is already established when the circuit becomes open due to conductor or connector failure.

In some applications, many or all modules may already be interconnected via network links, such as a Controller Area Network (CAN) bus, a Local Interconnect Network (LIN) bus, Ethernet, and so on. In some applications, a DC load may include an embedded input voltage sensor to enable internal power control. In accordance with the present disclosure, an arc detection and mitigation system may leverage an existing communication network to enable arc detection and mitigation while avoiding excessive additive costs. For example, in general, one or more parameters indicative of a voltage at a load of the application may be compared with one or more additional parameters indicative of an additional voltage at a power source (e.g., battery) of the application. The comparison may include determining a voltage differential between the voltage at the load and the additional voltage at the power source. A series arc may be detected or otherwise inferred based on the voltage differential. For example, the series arc may be detected or otherwise inferred in response to the voltage differential exceeding a threshold voltage differential. As previously described, a preexisting communication network may be employed to communicate mitigating responses to the detected or otherwise inferred series arc, such as an instruction to open a switch that blocks a flow of power between the power source and the load. The preexisting communication network may also be employed to communicate between a load microcontroller unit (MCU) and a power source microcontroller unit (MCU), such as transmitting data indicative of the above-described parameter indicative of the voltage at the load and the above-described additional parameter indicative of the additional voltage at the power source. It should be noted that use of “source” below, such as “source MCU,” is meant to denote “power source,” such as “power source MCU.”

In one embodiment in accordance with the present disclosure, a DC power distribution system may include a bus voltage sensor, one or more MCUs (or one or more electronic control units (ECUs), such as the load MCU and the power source MCU, and a power switch (e.g., a transistor, a relay, and so on) at the power source. The DC power distribution system may include the input voltage sensor and the load MCU at the electrical load, and a communication network between the power source (e.g., the power source MCU) and the electrical load (e.g., the load MCU).

The load MCU may periodically measure input load voltage. The rate of measurement may include 1 hertz (Hz) or more, 20 Hz or more, 30 Hz or more, 50 Hz or more, 100 Hz or more, 1,000 Hz or more, 2,000 Hz or more, 5,000 Hz or more, and so on. A moving average may be applied to the input load voltage measurement. The moving average may be applied over a number of samples, including 2 or more samples, 5 or more samples, 10 or more samples, 100 samples or more, and so on. The averaged input load voltage measurement values may be sent from the load MCU to the source MCU via the communication channel. The values may be sent at a communication frequency equal to or less than the measurement frequency. That is, the communication frequency may include 1 Hz or more, 20 Hz or more, 30 Hz or more, 50 Hz or more, 100 Hz or more, 1,000 Hz or more, 2,000 Hz or more, 5,000 Hz or more, and so on.

The source MCU may use the received measurements, which may trigger a windowing event (e.g., performing an aggregate-like operation on a group of samples within a “window”) to select the measured samples on the source-side bus voltage sensor. This may enable operation with an asynchronous communication layer. In some embodiments, the measurements (e.g., corresponding to the input load voltage(s)) received at the source MCU may be time-stamped to enable or improve processing related to the asynchronous communication layer. The measured source-side bus voltage samples may be averaged and the average source-side bus voltage value is compared to the averaged input load voltage measurement values from the load MCU. While this and other embodiments described in the present disclosure refer to an “average” or “averaged” voltages (e.g., corresponding to an average of multiple voltage measurements or readings), other mathematical representations are also possible, such as a median, a mode, a maximum, a minimum, etc. In general, a parameter indicative of the source-side bus bar voltage (or samples thereof) and an additional parameter indicative of the input load voltage (or samples thereof) may be employed.

The source MCU may determine if the voltage reported by the load is different than (e.g., lower than) the source voltage by a threshold amount for one or more events, and then the source MCU may open the power switch to interrupt the current flow in the circuit and extinguish the arc. The threshold may include a percentage voltage difference between the load voltage and the source voltage (e.g., 1% difference or more, 2% difference or more, 10% difference or more, and so on) or may include a predefined total voltage difference (e.g., a difference of 1 V or more, a difference of 10 V or more, a difference of 25 V or more, and so on). This threshold may be selected or otherwise set to capture detection of an electrical arc without false positives that may otherwise occur based on transient operating parameters (e.g., voltage), and may be dependent on the voltage of the application at issue (e.g., relatively high voltage applications may have a higher voltage differential than relatively low voltage applications). In some embodiments, the source MCU may also determine a presence of the arc based on the voltage differential exceeding the threshold voltage for a period of time above a time threshold period of time or for a number of samples above a threshold number of samples.

It should be noted that, while the load MCU is discussed as performing a certain set of operations and the source MCU is discussed as performing a different set of operations, the load MCU and the source MCU may be implemented to perform any or all of the operations. For example, in some embodiments, the source MCU may collect source voltage measurements, report the source voltage measurements to the load MCU, the load MCU may determine if the load voltage is different than (e.g., lower than) the source voltage by the threshold amount for the one or more events (based on the measured load voltage and the received source voltage measurements). Further, the load MCU may cause the electrical load to reduce its input current consumption to a value low enough to cause the arc to self-extinguish, or the load MCU may cause the source MCU to open the power switch to interrupt the current and extinguish the arc.

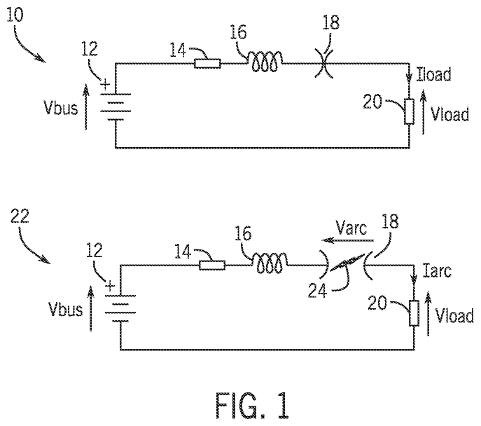

With the foregoing in mind, FIG. 1 is a schematic diagram illustrating a DC circuit 10 without an electrical arc and a DC circuit 22 with an electrical arc 24. The DC circuit 22 may be the same as the DC circuit 10, except that the electrical arc 24 is present in the DC circuit 22.

As shown, the DC circuit 10 includes a power supply 12, a parasitic resistance 14 (e.g., inherent resistance in the DC circuit 10), a parasitic inductance 16 (e.g., inherent inductance in the DC circuit 10), an electrical connection 18, and an electrical load 20. In some instances, the electrical connection 18 may fail open. The electrical connection 18 may include a switch that faults open or simply a wire or bus that becomes cut or otherwise disconnected. If the electrical connection 18 fails open while the power supply 12 continues to provide voltage and current to the electrical load 20, the voltage across a gap in the open electrical connection 18 may result in a sustained electrical arc, as shown by the electrical arc 24 in the DC circuit 22.

In some cases, arc detection may be accomplished via frequency-domain signature detection. Frequency-domain signature detection may include detecting a high frequency signature of an electrical arc in the current of a system by sampling current in the line at relatively high frequencies (e.g., several hundred kilohertz (kHz) to several megahertz (MHz)), converting the time-based measurement into the frequency domain (e.g., with the use of a fast Fourier transform), and identifying a particular pattern that resembles an electrical arc. When the pattern is identified, if the pattern suggests the presence of an electrical arc, the circuit may be opened by some active system (e.g., a transistor, a solid-state switch, a relay, and so on).

However, frequency-domain signature detection may have inherent disadvantages. For example, implementing frequency-domain signature detection may be expensive, may require a dedicated microcontroller unit (MCU) for each line, which may consume excessive space on an integrated circuit or a printed circuit board (PCB), may require a detection algorithm that necessitates adjustment and tuning for each individual application and for each electrical load within the application, and may result in the presence of false positive arc detections, particularly in systems where the electrical loads include active switching components (e.g., a motor drive, a computer, and so on).

In other cases, arc detection may be accomplished via analog voltage feedback (e.g., “remote-sense” arc detection). A remote-sense arc detection circuit may include a power source, a resistive device, a switching device (e.g., a transistor), an MCU, a source-side current sensor an electrical harness, signal wires, a load-side current sensor, an acquisition unit, and an electrical load. In the remote-sense arc detection circuit, the signal wires are implemented as additional wires between the electrical load and the source (e.g., the power source and the MCU) to detect a sudden voltage drop. The signal wires are not used to carry substantial current, but rather are used in one component of the remote-sense arc detection circuit (e.g., either the source or the electrical load) to measure the voltage seen by the other component (the electrical load or the source, respectively). A comparator (e.g., implemented in the MCU or the acquisition unit) may continuously monitor for discrepancies between the voltage at the power source and the electrical load. If a voltage drop indicative of an electrical arc (e.g., a voltage drop above a determined threshold) is detected, the electrical load may be deactivated, extinguishing the arc.

However, remote-sense arc detection circuit may have certain disadvantages, such as requiring the signal wires for arc detection doubles the number of wires, which may be more expensive an undesirable for certain applications (e.g., automotive applications), and additional circuitry may be required to sense and compare the source and load voltages, increasing cost and space consumed in the remote-sense arc detection circuit (e.g., consumed on an integrated circuit or PCB). If a chassis is used as a current carrier (e.g., such as the ground of an automobile), a separate ground sense wire may be needed to detect an arc formed in the ground current path, increasing circuit complexity. Moreover, the associated failure rate of the remote-sense arc detection circuit may increase with the presence of the extra sense lines and analog circuitry. Accordingly, it may be desirable to implement an arc detection circuit with fast and robust arc detection with fewer sense lines and simpler circuitry.

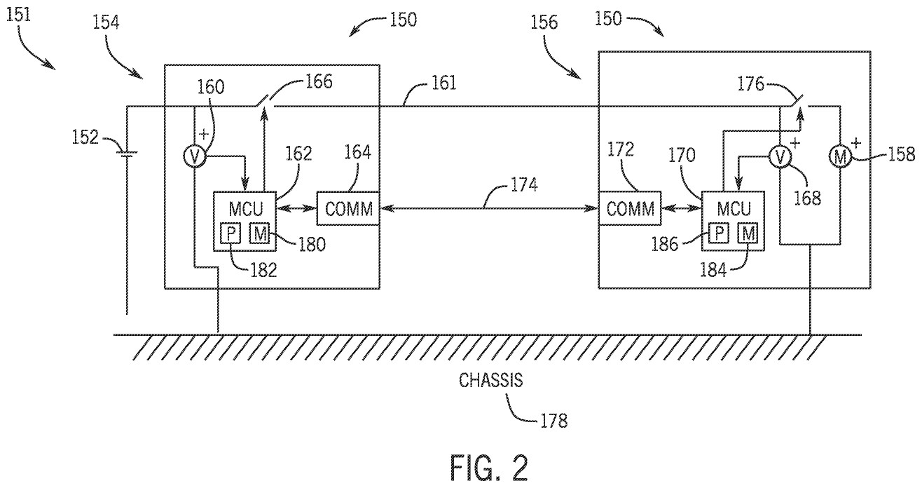

In some applications (e.g., photovoltaic applications, automotive applications, server applications, and so on) many or all modules may already be interconnected via network links, such as a controller area network (CAN) bus, a local interconnect network (LIN) bus, Ethernet, and so on. In accordance with the present disclosure, such preexisting communication networks may be leveraged in FIG. 1 to provide series arc detection at little to no additional cost and with little to no additional space consumed or system complexity. For example, FIG. 2 is a block diagram of an arc detection system 150 employed for a power system 151, where the arc detection system 150 includes network-based arc detection and mitigation circuitry, according to embodiments of the present disclosure. The power system 151 includes a power source 152 (e.g., a battery) and an electrical load 158. The arc detection system 150 of the power system 151 includes source circuitry 154 disposed at or adjacent to the power source 152, and load circuitry 156 at or adjacent to the electrical load 158. The electrical load 158 may include any electrical load coupled to a communication network, such as an electrical motor, a battery, photovoltaic cells, audio amplifiers, audiovisual systems, or any other electrical load appropriate for the arc detection system 150 or any electrical system.

The source circuitry 154 in the illustrated embodiment includes a bus voltage sensor 160 coupled to a power bus 161, a source MCU 162 communicatively coupled to the voltage sensor 160, a communication interface 164 communicatively coupled to the source MCU 162, and a switch 166 (e.g., a transistor). The load circuitry 156 includes a load voltage sensor 168, a load MCU 170 communicatively coupled to the load voltage sensor 168, and a communication interface 172, where the communication interface 172 is communicatively coupled to the load MCU 170 and the communication interface 164 of the source circuitry 154. The source circuitry 154 and the load circuitry 156 may communicate with each other via the communication interface 172, the communication interface 164, and a communication link 174 between the communication interfaces 164, 172. The communication link 174 may be wired or wireless, and may include, for example, a LIN connection, a CAN connection, an Ethernet connection, or any other appropriate communication standard or protocol. In certain embodiments, the communication link 174 may be employed for other communications associated with the power system 151 besides arc detection disclosed by the present disclosure, such as sharing essential control data (e.g., of a vehicle). The load circuitry 156 includes a switch 176 configured to couple or decouple the electrical load 158 to or from the power source 152. The power source 152, the source circuitry 154, and the load circuitry 156 may be grounded to a chassis 178.

The source circuitry 154 and the load circuitry 156 are configured to measure their respective power terminal voltages (e.g., via the voltage sensors 160 and 168 and the MCUs 162 and 170, respectively) at regular intervals. If a voltage differential above a voltage differential threshold (e.g., 1 V or more, 2 V or more, 5 V or more, 10 V or more, 20 V or more, and so on) is identified, then the power source 152 may be disconnected from the electrical load 158. In some embodiments, the disconnection may occur after the voltage differential exceeds the voltage differential threshold for a period of time above a time threshold (e.g., 10 milliseconds (ms) or more, 50 ms or more, 100 ms or more, 1 second or more, and so on). Further, in some embodiments, voltage readings by the voltage sensor 160 may be averaged, and voltage readings by the voltage sensor 168 may be averaged, such that a comparison between the averaged input voltage measurements and the averaged source-side voltage measurements is performed to determine the voltage differential (e.g., averaged voltage differential).

In this way, transient spikes may be omitted from the comparison, thereby reducing or negating false detections of electrical arcs. However, other mathematical representations of the source-side voltage and the input voltage may be employed in certain embodiments, such as a median, a mode, a maximum, a minimum, etc. The above-described processing steps (e.g., determining the voltage different, comparing the voltage differential with the threshold voltage differential, etc.) may be performed by the source MCU 162, the load MCU 170, or a combination thereof. For example, the source MCU 162 may include memory circuitry 180 storing instructions thereon that, when executed by processing circuitry 182 of the source MCU 162, cause the processing circuitry 182 to perform various functions (e.g., all or some of the processing steps described above). Additionally or alternatively, the load MCU 170 may include memory circuitry 184 storing instructions thereon that, when executed by processing circuitry 186 of the load MCU 170, cause the processing circuitry 186 to perform various functions (e.g., all or some of the processing steps described above). Indeed, input voltage measurements (or an average of various input voltage measurements) may be transmitted to the source MCU 162 via the communication link 174 in one embodiment, while in another embodiment, source-side voltage measurements (or an average of the source-side voltage measurements) may be transmitted to the load MCU 170 via the communication link 174.

The arc detection system 150 may enable accurate arc detection despite relatively slow measurements, which may result in less intensive processing power and less costly operation. As previously described, disclosed embodiments may enable accurate arc detection despite asynchronous communication layers. For example, data communicated between the MCUs 162, 170 may be time-stamped, or the receiving MCU 162 or 170 may be capable of determining a time of the measurements at issue in the received data based on a known delay period. These and other aspects of the present disclosure are described in detail below.

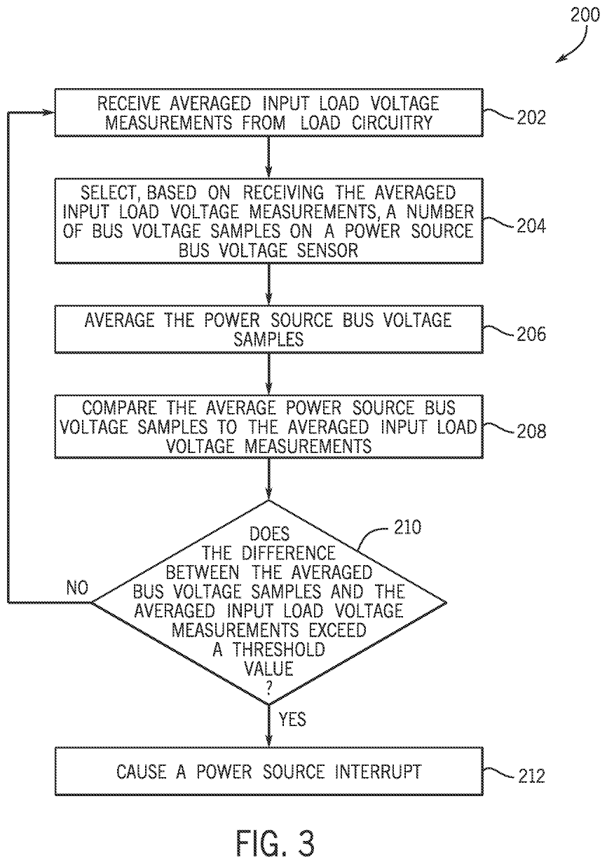

FIG. 3 is a flowchart of a method 200 for arc detection and response via the arc detection system 150 of FIG. 2, according to embodiments of the present disclosure. The discussion below includes reference numerals illustrated in FIG. 2.

Any suitable device(s) (e.g., a controller) that may process data and/or control components of the arc detection system 150, such as the processing circuitry 182 of the source MCU 162, may perform all or some of the method 200. In some embodiments, the method 200 may be implemented by executing instructions stored in a tangible, non-transitory, computer-readable medium, such as the memory circuitry 180 of the source MCU 162. For example, the method 200 may be performed at least in part by one or more logic or software components, such as an operating system used to control one or more components of the arc detection system 150, one or more software applications implemented in the arc detection system 150, and the like. While the method 200 is described using steps in a specific sequence, it should be understood that the present disclosure contemplates that the described steps may be performed in different sequences than the sequence illustrated, and certain described steps may be skipped or not performed altogether.

In process block 202, the source MCU 162 receives input load voltage measurements from the load MCU 170. For example, the load MCU 170 may sample the voltage across the electrical load 158 at 10× the communication frequency (e.g., a clock frequency of the load MCU 170). The load MCU 170 may then average those 10 samples (e.g., via a moving average) and report (e.g., output) that average to the source MCU 162 via the communication link 174 and the communication interfaces 164 and 172. In some embodiments, the averaging step may be performed by the source MCU 162 based on data received from the load MCU 170. The source MCU 162 may sample bus voltage (e.g., output voltage) measurements, but may not take a set number of samples of the bus voltage in certain embodiments. Instead, in certain embodiments, the source MCU 162 may trigger a windowing event where a number of samples in a window is dynamically determined based on the received averaged input load voltages (or individual input load voltage measurements). The communication frequency may be determined based on current through the power bus 161. In some embodiments, as the power delivered to the electrical load 158 (and thus the current delivered to the electrical load 158) increases, the communication frequency, and thus the voltage sampling of the of the power bus 161 or the voltage sampling frequency across the electrical load 158 increases. For example, in a 100 V system with two loads, voltage across a low-current load may be sampled at a frequency of 10 kHz and voltage across a high-current load may be sampled at a frequency of 100 kHz. The voltage may be reported to the source MCU 162 or the load MCU 170 once every sample, once every 10 samples, once every 100 samples, and so on. In some embodiments, the averaged input load voltage (or the individual input load voltage measurements) may be time-stamped, or the source MCU 162 may otherwise determine a timing of the averaged input load voltage (or the individual load voltage measurements) (e.g., based on a known communication delay or clock).

In process block 204, the source MCU 162 selects, based on receiving and/or determining the averaged input load voltage measurements, a number of samples of bus voltage measurements (e.g., output voltage measurements) measured on the bus voltage sensor 160. For example, the source MCU 162 may select 5 bus voltage samples or more, 10 bus voltage samples or more, 20 bus voltage samples or more, and so on based on receiving the averaged input load voltage. In process block 206, the source MCU 162 averages the power source bus voltage samples.

In process block 208, the source MCU 162 compares the averaged source bus voltage samples to the averaged input load voltage measurements (e.g., taken by the load voltage sensor 168). In query block 210, the source MCU 162 determines whether a difference between the averaged bus voltage samples and the averaged input load voltage measurements (e.g., voltage differential or averaged voltage differential) exceeds a voltage threshold value (e.g., voltage differential threshold value). As previously discussed, the voltage threshold may include a voltage of 1 V or more, 2 V or more, 5 V or more, 10 V or more, 20 V or more, and so on. In some embodiments, such as those employing a moving or rolling average, the source MCU 162 may determine that the voltage differential persists for a number of samples. For example, the source MCU 162 may determine that the voltage differential indicates an electrical arc based on the voltage differential exceeding a voltage threshold for 2 consecutive samples or more, 3 consecutive samples or more, 10 consecutive samples or more, and so on. In other embodiments, the source MCU 162 may determine if the voltage difference persists beyond a threshold period of time. The threshold period of time may include a time span of 10 ms or more, 50 ms or more, 100 ms or more, 1 second or more, and so on.

For example, if the voltage differential threshold is set at 10 V for 3 consecutive samples and if the source MCU 162 determines that the difference between the averaged bus voltage samples taken by the bus voltage sensor 160 and the input load voltage samples taken by the load voltage sensor 168 is greater than 10 V for greater than 3 consecutive samples, in process block 212, the source MCU 162 will cause a power source interrupt. The source MCU 162 may cause a power source interruption by opening the switch 166, thereby disconnecting the power source 152 from the load circuitry 156. Alternatively, the source MCU 162 may send a command to the load MCU 170 via the communication link 74 to open the switch 176 or otherwise reduce the current consumption of the electrical load 158.

As another example, if the voltage differential threshold is set at 10V and the threshold period of time is set at 100 ms, and if the source MCU 162 determines that the difference between the averaged bus voltage samples taken by the bus voltage sensor 160 and the input load voltage samples taken by the load voltage sensor 168 is greater than 10 V for 150 ms, in process block 214, the source MCU 162 will cause a power source interrupt or send instructions to the load MCU 170 as discussed above.

However, if the source MCU 162 determines that the difference between the averaged bus voltage samples and the input load voltage samples is less than or equal to 10 V (or some other threshold, such as a threshold in a range of 1-20 V, a threshold in a range of 2-18 V, a threshold in a range of 4-16 V, a threshold in a range of 6-14 V, 8-12 V, etc.), the source MCU 162 may leave the switch 166 closed, and continue to receive the input load voltage measurements from the load circuitry 156 as discussed with respect to process block 202. In general, the threshold may be dependent on the normal voltage of the application at issue (e.g., higher voltage applications may include a relatively high threshold, whereas lower voltage applications may include a relatively low threshold).

Additionally, if the source MCU 162 determines that the voltage differential above the threshold persists for a number of samples below the sample threshold (e.g., persists for 2 consecutive samples) or for a length of time below the time threshold (e.g., 10 ms), the source MCU 162 may leave the switch 166 closed, and continue to receive the input load voltage measurements from the load circuitry 156.

In some instances, communication may be lost in the power system 151 due to a series-arc event (e.g., an arc may occur on a power-ground return connection of the source circuitry 154 or the load circuitry 156). If communication is lost, then the arc may continue unabated, with no mechanism to extinguish the arc. To address this issue, a timeout mechanism may be implemented such that the source MCU 162 may determine if communication has not been received from the load circuitry 156 (e.g., the load MCU 170) or such that the load MCU 170 may determine if communication has not been received from the source circuitry 154 (e.g., the source MCU 162) for a period of time greater than a threshold period of time. The threshold period of time may include 10 ms or more, 100 ms or more, 1 second or more, and so on. If the source MCU 162 or load MCU 170 determines that no communication has been made with the load circuitry 156 or the source circuitry 154, respectively, for greater than the threshold period of time, the source MCU 162 or load MCU 170 will cause a power source interrupt or cause the load circuitry 156 to reduce power consumption, as discussed above. In this manner, the method 200 may detect a voltage difference or a loss of communication indicative of an electrical arc in the arc detection system 150 and may act to mitigate or eliminate the electrical arc via the source MCU 162.

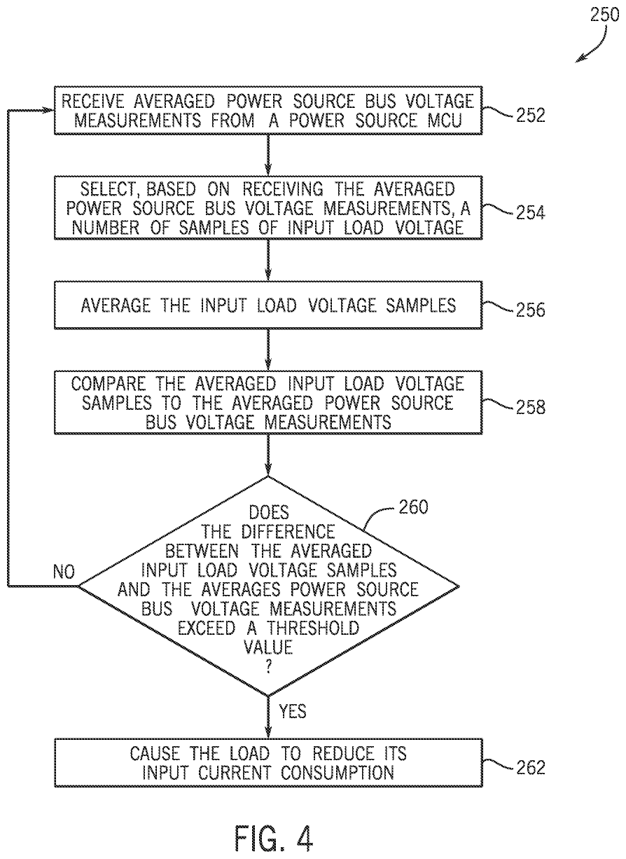

FIG. 4 is a flowchart of a method 250 for arc detection and response via, for example, the load MCU 170 (e.g., the processing circuitry 186 thereof) of the arc detection system 150, according to embodiments of the present disclosure. The discussion below includes reference numerals illustrated in FIG. 2.

Any suitable device(s) (e.g., a controller) that may process data and/or control components of the arc detection system 150, such as the processing circuitry 186 of the load MCU 170, may perform all or some of the method 250. In some embodiments, the method 250 may be implemented by executing instructions stored in a tangible, non-transitory, computer-readable medium, such as the memory circuitry 184 of the load MCU 170, using the processing circuitry 186 of the load MCU 170. For example, the method 250 may be performed at least in part by one or more logic or software components, such as an operating system used to control one or more components of the arc detection system 150, one or more software applications implemented in the arc detection system 150, and the like. While the method 250 is described using steps in a specific sequence, it should be understood that the present disclosure contemplates that the described steps may be performed in different sequences than the sequence illustrated, and certain described steps may be skipped or not performed altogether.

In process block 252, the load MCU 170 receives averaged power source bus voltages measurements (e.g., from the source MCU 162) via the communication interfaces 164 and 172 and the communication link 174. In process block 254, the load MCU 170 selects, based on receiving the averaged power source bus voltage measurements, a number of samples of the input load voltage (e.g., measured by the input load voltage sensor 168). In process block 256, the load MCU 170 averages the input load voltage samples. In process block 258, the load MCU 170 compares the averaged input load voltage samples to the averaged power source bus voltage measurements received from the source MCU 162.

In query block 260, the load MCU 170 determines whether a difference between the averaged input load voltage samples and the averaged power source bus voltage measurements (e.g., voltage differential or averaged voltage differential) exceed a threshold voltage value (e.g., voltage differential threshold value). Similar to the voltage thresholds discussed with respect to query block 210 of FIG. 3, the voltage threshold may include a voltage of 1 V or more, 2 V or more, 5 V or more, 10 V or more, 20 V or more, and so on. In some embodiments, such as those employing a moving or rolling average, the load MCU 170 may determine that the voltage differential persists for a number of samples. For example, the load MCU 170 may determine that the voltage differential indicates an arc based on the voltage differential exceeding a voltage threshold for 2 consecutive samples or more, 3 consecutive samples or more, 10 consecutive samples or more, and so on. In other embodiments, the source MCU 162 may determine if the voltage difference persists beyond a threshold period of time. The threshold period of time may include a time span of 10 ms or more, 50 ms or more, 100 ms or more, 1 second or more, and so on.

For example, if the voltage differential threshold is set at 10V and the threshold period of time is set at 100 ms, and if the load MCU 170 determines that a voltage difference between the averaged input load voltage samples and the averaged power source bus voltage is greater than 10 V for 150 ms, in process block 262, the load MCU 170 will cause a power source interrupt (e.g., via the switch 176) and/or its input current consumption to a value low enough to cause any resultant arc to self-extinguish. In other embodiments, the load MCU 170 may also send a command to the source MCU 162 causing the source MCU 162 to interrupt the power source by opening the switch 166 and disconnecting the power source 152 from the load circuitry 156. The load MCU 170 may interrupt the power supply by causing the switches 166 and/or 176 to open based on determining that the voltage differential continues to exceed the threshold after causing the electrical load 158 to reduce its power consumption.

However, if the load MCU 170 determines that the voltage difference between the averaged input load voltage samples and the averaged power source bus voltage is less than or equal to 10 V (or some other threshold, such as a threshold in a range of 1-20 V, a threshold in a range of 2-18 V, a threshold in a range of 4-16 V, a threshold in a range of 6-14 V, 8-12 V, etc.), the load MCU 170 may refrain from causing the electrical load 158 from adjusting its input current consumption and may leave the switch 176 closed, and continue to receive the averaged power source bus voltage measurements as discussed with respect to process block 252. Additionally, if the load MCU 170 determines that the voltage difference persists for only 10 ms, the load MCU 170 may refrain from causing the electrical load 158 from adjusting its input current consumption and may leave the switch 176 closed and continue to receive the averaged power source bus voltage measurements.

Similarly as to what was discussed above with respect to FIG. 3, in some instances, communication may be lost in the power system 151 due to a series-arc event (e.g., an arc may occur on a power-ground return connection of the source circuitry 154 or the load circuitry 156). If communication is lost, then the arc may continue unabated, with no mechanism to extinguish the arc. To address this issue, a timeout mechanism may be implemented such that the load MCU 170 may determine if communication has not been received from the source circuitry 154 (e.g., the source MCU 162) or such that the source MCU 162 may determine if communication has not been received from load circuitry 156 (e.g., the load MCU 170) for a period of time greater than a threshold period of time. The threshold period of time may include 10 ms or more, 100 ms or more, 1 second or more, and so on. If the load MCU 170 or the source MCU 162 determines that no communication has been made with the source circuitry 154 or the load circuitry 156, respectively, for a period of time greater than the threshold period of time, the load MCU 170 or the source MCU 162 will interrupt the power supply by causing the switches 166 and/or 176 to open based or cause the load circuitry 156 to reduce its power consumption. In this manner, the method 250 may detect a voltage difference or a communication loss indicative of an electrical arc in the arc detection system 150 and may act to mitigate or eliminate the electrical arc via the load MCU 170.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A system, comprising:
an electrical load;
load circuitry coupled to the electrical load and configured to output first data indicative of a first average of input load voltages across the electrical load;
a power source; and
power source circuitry coupled to the power source and the load circuitry, the power source circuitry configured to interrupt the power source based on the first data indicative of the first average of the input load voltages and second data indicative of a second average of power source bus voltages.

2. The system of claim 1, wherein the load circuitry is configured to transmit the first data indicative of the first average of the input load voltages to the power source circuitry via a Controller Area Network (CAN) link.

3. The system of claim 1, wherein the load circuitry is configured to transmit the first data indicative of the first average of the input load voltages to the power source circuitry via a Local Interconnect Network (LIN) link.

4. The system of claim 1, wherein the load circuitry is configured to transmit the first data indicative of the first average of the input load voltages to the power source circuitry via an Ethernet link.

5. The system of claim 1, wherein the power source circuitry is configured to interrupt the power source based on an average voltage differential between the first average of the input load voltages and the second average of the power source bus voltages exceeding a threshold voltage differential.

6. The system of claim 5, wherein the power source circuitry is configured to interrupt the power source based on the average voltage differential exceeding the threshold voltage differential for a number of samples greater than a threshold number of samples.

7. The system of claim 5, wherein the power source circuitry is configured to interrupt the power source based on the average voltage differential exceeding the threshold voltage differential for a period of time greater than a threshold period of time.

8. The system of claim 1, wherein the power source circuitry is configured to interrupt the power source based on determining that communication has been lost between the power source circuitry and the load circuitry for a period of time greater than a threshold period of time.

9. An arc detection circuit, comprising:
a power bus;
a power source coupled to the power bus;
power source circuitry coupled to the power source and the power bus, the power source circuitry comprising:
a source voltage sensor configured to determine output voltages on the power bus; and
a first microcontroller unit (MCU) coupled to the source voltage sensor and configured to output first data indicative of a first average of the output voltages received from the source voltage sensor;
an electrical load coupled to the power bus; and
load circuitry coupled to the power bus and the electrical load, the load circuitry comprising:
a load voltage sensor configured to determine input voltages across the electrical load; and
a second MCU coupled to the load voltage sensor and configured to cause a load power reduction based on the first data indicative of the first average of the output voltages and second data indicative of a second average of the input voltages.

10. The arc detection circuit of claim 9, wherein the second MCU is configured to determine whether an average voltage differential between the second average of the input voltages and the first average of the output voltages exceeds a threshold value.

11. The arc detection circuit of claim 10, wherein the second MCU is configured to cause the load power reduction by causing the electrical load to reduce its current consumption based on determining that the average voltage differential exceeds the threshold value.

12. The arc detection circuit of claim 10, wherein the second MCU is configured to open a switch based on determining that the average voltage differential exceeds the threshold value.

13. The arc detection circuit of claim 10 wherein the second MCU is configured to send a command to the first MCU, the command causing the first MCU to open a switch based on determining that the average voltage differential exceeds the threshold value.

14. The arc detection circuit of claim 10, wherein the load voltage sensor is configured to measure a plurality of input voltages across the electrical load, the plurality of input voltages including the input voltages and extra input voltages, and the second MCU is configured to select the input voltages and exclude the extra input voltages, such that the second average of the input voltages is based on the input voltages and not the extra input voltages.

15. The arc detection circuit of claim 10, wherein the second MCU is configured to cause the load power reduction based on the average voltage differential exceeding the threshold value for a period of time above a threshold period of time.

16. The arc detection circuit of claim 10, wherein the second MCU is configured to cause the load power reduction based on the average voltage differential exceeding the threshold value for a number of consecutive samples above a threshold number of consecutive samples.

17. The arc detection circuit of claim 9, wherein the second MCU is configured to cause the load power reduction based on determining that communication has been lost between the power source circuitry and the load circuitry for a period of time greater than a threshold period of time.

18. The arc detection circuit of claim 9, wherein the second MCU is configured to increase a sampling rate of the input voltages based on the electrical load consuming a first amount of current, and is configured to reduce the sampling rate of the input voltages based on the electrical load consuming a second amount of current, wherein the first amount of current is greater than the second amount of current.

19. A tangible, non-transitory, computer-readable medium, comprising instructions that, when executed by one or more processors, are configured to cause the one or more processors to:
determine a plurality of output voltages corresponding to a power source;
determine a first average of the plurality of output voltages;
determine a plurality of input voltages corresponding to a load coupled to the power source;
determine a second average of the plurality of input voltages; and
interrupt a flow of power from the power source to the load based on the first average of the plurality of output voltages and the second average of the plurality of input voltages.

20. The tangible, non-transitory, computer readable medium of claim 19, wherein the instructions are configured to cause the one or more processors to interrupt the flow of power by opening a switch coupled to a power bus between the power source and the load.
